(19) United States
(12) Patent Application Publication
(10) Pub. No.: US 2026/0056084 A1
(43) Pub. Date: Feb. 26, 2026

(54) EVAPORATIVE EMISSIONS LEAK DETECTION MODULE

(71) Applicants: Stoneridge Asia Pacific Electronics ( Suzhou ) Co. Ltd., Suzhou (CN); Stoneridge Control Devices, Inc., Novi, MI (US)

(72) Inventors: Nick Xue, Suzhou (CN); Sean Gao, Suzhou (CN); Terry Yu, Suzhou (CN); Wells Jiang, Suzhou (CN); Ben Zhang, Suzhou (CN)

(21) Appl. No.: 18/830,841

(22) Filed: Sep. 11, 2024

(30) Foreign Application Priority Data
Aug. 22, 2024 (CN) 2024220485786

(51) Int. Cl. G01M 3/28; F02M 25/08

(52) U.S. Cl. CPC G01M 3/2876; F02M 25/0809

(57) ABSTRACT

A Leak Detection Module may include a housing, wherein the housing is positioned between a charcoal cannister and atmosphere and the housing includes a first port fluidly communicating the housing to the cannister and a second port fluidly communicating the housing to the atmosphere. A Leak Detection Module may include a canister valve solenoid (CVS) arranged within the housing and in fluid communication along a first fluid passageway between the first and second ports, the CVS movable between open and closed positions. A Leak Detection Module may include a pump arranged within the housing and in fluid communication along a second fluid passageway between the first and second ports, wherein the first and second fluid passageways are parallel to each other. A Leak Detection Module may include a fuel tank isolation valve system (FTIV) to facilitate the flow of fluid between the cannister and atmosphere, wherein the FTIV is arranged within the housing between the first port and both the first and second fluid passageway and the FTIV is in fluid communication with the first port, the first fluid passageway, and the second fluid passageway, the FTIV further including a first chamber, a second chamber, and a third chamber that together define a plurality of fluid paths through the FTIV, the FTIV further including a solenoid valve and a mechanical bypass system, wherein the solenoid valve is electrically controlled to open and close and regulates the communication of fluid through a first fluid path of the plurality of fluid paths, and the mechanical bypass system responds automatically to either positive or negative pressure differentials across the chambers and regulates the communication of fluid through a second fluid path of the plurality of paths.

### PRIORITY CLAIM

This application claims priority to Chinese Patent Application No. 2024220485786 filed Aug. 22, 2024.

### TECHNICAL FIELD

This disclosure relates to a leak detection module (LDM) for an evaporative emissions system.

### BACKGROUND

Evaporative emissions systems have long been required for gasoline powered vehicles. The system must undergo a periodic leak test during or after a vehicle drive cycle to ensure that fuel vapors will not leak into the atmosphere. Various valves may be closed during this test procedure to maintain system pressure, and the pressure is monitored to determine if there are any leaks.

One type of evaporative emissions system uses a leak detection module (LDM) that typically houses a pump and one or more valves in a common housing for performing the leak test. Further a fuel tank isolation valve is used to selectively block the flow of fuel vapors from the fuel tank.

### SUMMARY

In some aspects, the techniques described herein relate to a leak detection module (LDM) including: a housing, wherein the housing is positioned between a charcoal cannister and atmosphere and the housing includes a first port fluidly communicating the housing to the cannister and a second port fluidly communicating the housing to the atmosphere; a canister valve solenoid (CVS) arranged within the housing and in fluid communication along a first fluid passageway between the first and second ports, the CVS movable between open and closed positions; a pump arranged within the housing and in fluid communication along a second fluid passageway between the first and second ports, wherein the first and second fluid passageways are parallel to each other; a fuel tank isolation valve system (FTIV) to facilitate the flow of fluid between the cannister and atmosphere, wherein the FTIV is arranged within the housing between the first port and both the first and second fluid passageway and the FTIV is in fluid communication with the first port, the first fluid passageway, and the second fluid passageway, the FTIV further including a first chamber, a second chamber, and a third chamber that together define a plurality of fluid paths through the FTIV, the FTIV further including a solenoid valve and a mechanical bypass system, wherein the solenoid valve is electrically controlled to open and close and regulates the communication of fluid through a first fluid path of the plurality of fluid paths, and the mechanical bypass system responds automatically to either positive or negative pressure differentials across the chambers and regulates the communication of fluid through a second fluid path of the plurality of paths.

In some aspects, the techniques described herein relate to a module, wherein the first chamber is positioned between the first port and second chamber, the second chamber is positioned between the first chamber and third chamber, and the third chamber is positioned between the second chamber and both the first and second fluid passageway.

In some aspects, the techniques described herein relate to a module, wherein the first fluid path communicates fluid between the first and third chamber.

In some aspects, the techniques described herein relate to a module, wherein the second fluid path communicates fluid from the first chamber to the second chamber to the third chamber and also from the third chamber to the second chamber to the first chamber.

In some aspects, the techniques described herein relate to a module, wherein a relief hole between the first and second chamber fluidly communicates the first and second chamber.

In some aspects, the techniques described herein relate to a module, wherein a relief valve is positioned between the second and third chamber to control the communication of fluid flowing in the direction of the first port to the second port.

In some aspects, the techniques described herein relate to a module, wherein an air supply spring is positioned between the second and third chamber to control the communication of fluid flowing in the direction of the second port to the first port.

In some aspects, the techniques described herein relate to an evaporative emissions system including the leak detection module, the system including: an engine configured to provide vehicle propulsion; a fuel tank configured to contain fuel and fuel vapors selectively supplied to the engine; the charcoal canister configured to store the fuel vapors from the fuel tank; a purge valve in fluid communication with the charcoal canister and configured to selectively provide the fuel vapors to an engine in response to a purge command.

In some aspects, the techniques described herein relate to a leak detection module (LDM) including: a housing, wherein the housing is positioned between a charcoal cannister and atmosphere and the housing includes a first port fluidly communicating the housing to the cannister and a second port fluidly communicating the housing to the atmosphere; a canister valve solenoid (CVS) arranged within the housing and in fluid communication along a first fluid passageway between the first and second ports, the CVS is electrically controlled by a controller to move between open and closed positions; a pump arranged within the housing and in fluid communication along a second passageway between with the first and second ports, wherein the first and second fluid passageways are parallel to each other; an umbrella check valve arranged within the housing and in fluid communication along the second passageway between the first port and the pump, wherein the umbrella check valve is a one-way mechanical valve that is configured to communicate the flow of fluid from the second port to the first port along the second passageway and to prevent the communication of fluid from the first port to the second port along the second passageway; a pressure sensor in fluid communication with at least one of the first and second ports.

In some aspects, the techniques described herein relate to a LDM, wherein the umbrella check valve includes a stem that is secured to a convex sealing disk.

In some aspects, the techniques described herein relate to a LDM, wherein the second passageway includes a seat situated perpendicular to and across the second passageway, and the seat is configured to receive the umbrella check valve.

In some aspects, the techniques described herein relate to a LDM, wherein the seat receives the umbrella check valve so that the stem protrudes through a first side of the seat, and the sealing disk is pressed flush to an opposite, second side of the seat.

### BRIEF DESCRIPTION OF THE DRAWINGS

The disclosure can be further understood by reference to the following detailed description when considered in connection with the accompanying drawings wherein:

FIG. 1 schematically illustrates portions of one example evaporative emissions system.

FIG. 2 is a schematic view of a leak detection module (LDM) for the evaporative emissions system shown in FIG. 1.

FIG. 3 is a cross-sectional view of the LDM for the evaporative emissions system shown in FIG. 1.

FIG. 4 schematically illustrates portions of a second example evaporative emissions system.

FIG. 5 is a schematic view of the LDM for the evaporative emissions system shown in FIG. 4.

FIG. 6 is a computer-aided design (CAD) drawing showing a perspective view of the LDM for the evaporative emissions system shown in FIG. 4.

FIG. 7 is a CAD drawing showing a cross-sectional view of a fuel tank isolation valve (FTIV) system of the LDM for the evaporative emissions system shown in FIG. 4.

FIG. 8 is a CAD drawing showing a cross-sectional view of the mechanical bypass system of the FTIV system for the evaporative emissions system shown in FIG. 4.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible. Like reference numbers and designations in the various drawings indicate like elements.

### DETAILED DESCRIPTION

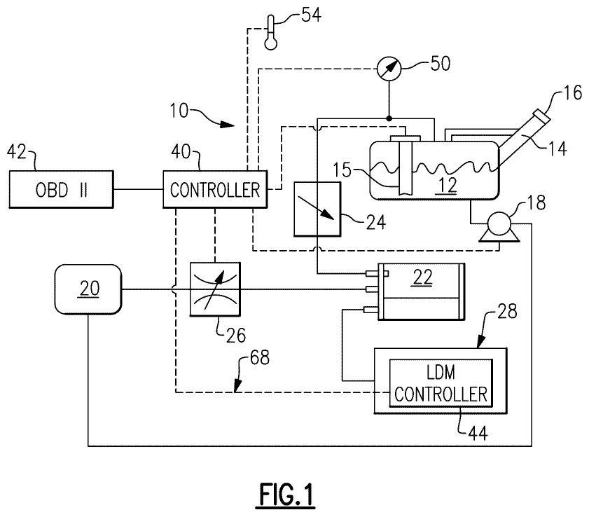

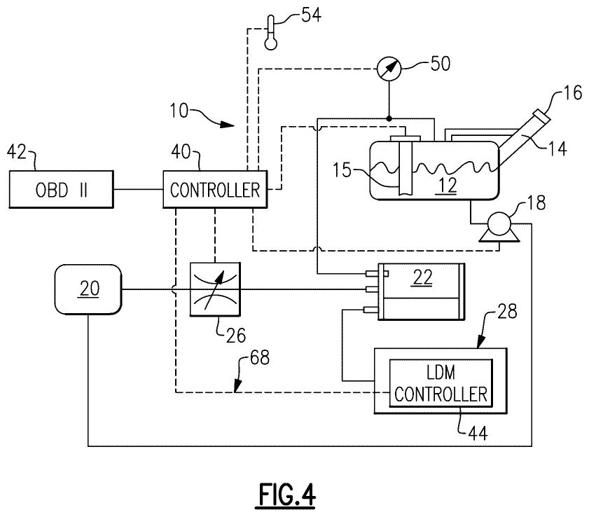

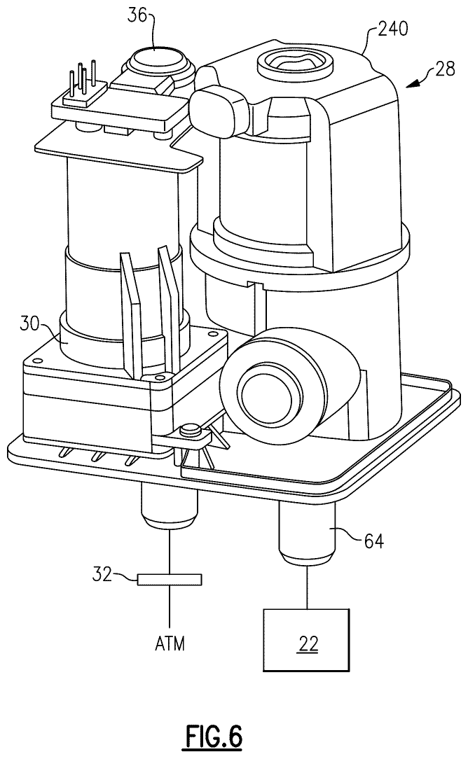

FIG. 1 schematically illustrates a portion of an example evaporative fuel system 10. It should be understood that other types of systems may be used, such as the system shown in FIG. 4. For each of the evaporative emissions systems shown in FIGS. 1-8, the evaporative emissions system 10 includes a fuel tank 12 having a fuel filler 14 with a fill cap 16. Further, a fuel pump 18 supplies gasoline, for example, from the fuel tank 12 to an internal combustion engine 20, which provides propulsion to a vehicle. Further, the evaporative emissions system 10 includes a fuel level sensor 15 in communication with a controller 40, which may be an engine controller, that measures a level of fuel within the fuel tank 12, which also correlates to an amount of fuel vapor within the fuel tank 12.

The evaporative emissions system 10 is configured to capture and regulate the flow of fuel vapors within the system. In the example shown in FIGS. 1-3, a fuel tank isolation valve (FTIV) system 24 is a solenoid that is arranged fluidly between the fuel tank 12 and a charcoal canister 22. In this arrangement, the primary function of the Ftiv system 24 is to control the flow of fuel vapors between the fuel tank 12 and charcoal canister 22.

The FTIV system 24 may be opened by electrical means or by mechanical bypasses. Whether the FTIV system 24 is opened or closed depends on the operational conditions of the vehicle and ambient temperatures. For example, during normal operation of the vehicle, when the vehicle's engine 20 is running, the FTIV system 24 remains open, allowing fuel vapors generated in the tank due to heat and fuel agitation to be drawn into the charcoal canister 22. In the example shown in FIGS. 1-3, when the vehicle's engine 20 is turned off, the FTIV system 24 is typically closed and blocks the flow of vapor between the fuel tank 12 and charcoal cannister 22.

A purge valve 26 is fluidly connected between the charcoal canister 22 and the engine 20. In one example, the controller 40 regulates a position of the purge valve 26 during engine operation in response to a purge command from the engine controller 40, for example, to selectively provide the fuel vapors to the engine 20 during fuel combustion to make use of these fuel vapors.

The integrity of the evaporative emissions system 10 must be periodically tested to ensure no fuel vapor leakage. One type of evaporative emissions system 10 uses a leak detection module (LDM) 28, which can be used to pull a vacuum and/or pressurize the system to determine whether a leak exists, for example, using a pressure transducer 52. In one example leak test procedure, the purge valve 26 is closed and the LDM controller 44 operates the leak detection module 28 to evacuate or pressurize the system. Another pressure transducer 50 may be used to monitor the pressure of fuel vapors within the fuel tank 12 during other conditions.

An ambient temperature sensor, which is optional, is in communication with the LDM controller 44. In one example, the temperature sensor 48 is arranged within a housing 46 and in fluid communication with at least one of the first and second ports 64, 66. In another example, the temperature sensor 54 is arranged outside the LDM 28. The temperature sensor 48 may be useful for quantifying heat transfer characteristics of the fuel vapor within the fuel tank 12 relative to surrounding atmospheric temperature.

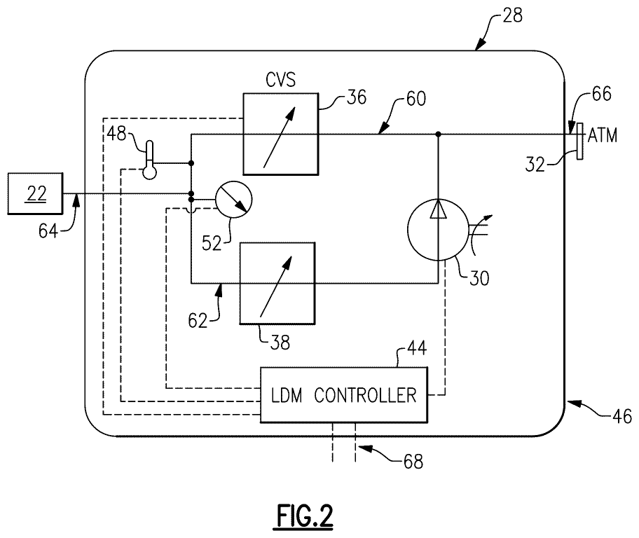

The LDM 28 has its own LDM controller 44, separate and discrete from the engine controller 40. The controllers 40, 44 are arranged remotely from one another in separate housings. Typically, the engine controller 40 is arranged at or near the vehicle's engine bay, and the LDM controller is arranged near the fuel tank 12 and/or charcoal canister 22, which is often at the rear of the vehicle. By using a separate LDM controller 44, the computation and control algorithms for leak diagnostics can be performed outside the engine controller 40, which can greatly simplify the engine controller's programming and I/O hardware. For example, instead of using eight wires from the LDM 28 to the engine controller 40, only two wires may be used between the engine and LDM controllers 40, 44 (i.e., two CAN bus wires; see at 68 in FIG. 2) Additionally, the overall power consumption during a leak test procedure may be reduced when using a separate LDM controller 44.

One example of the LDM 28 is schematically shown in FIG. 2. The LDM 28 includes a network of fluid passageways to fluidly communicate the evaporative emissions system 10 to the atmosphere including a cannister valve solenoid (CVS) fluid passageway 60 and a pump fluid passageway 62 that are both in fluid communication with a first and second port 64, 66. The first port 64 is a canister port configured to be fluidly connected to a charcoal canister 22, and the second port 66 is an atmospheric port configured to provide substantially atmospheric pressure. As shown in FIG. 2, the CVS and pump fluid passageways 60, 62 are routed parallel to each other and both passageways 60, 62 are arranged between the first and second port 64, 66 so as to converge at the first and second port 64, 66. In another example, the LDM 28 may include an additional fluid passageway having a pressure relief valve, where the additional fluid passageway is routed in parallel to the CVS and pump fluid passageways 60, 62.

The LDM 28 includes a canister valve solenoid (CVS) 36. The CVS 36 is arranged within the LDM housing 46 and in fluid communication along the CVS fluid passageway 60 between first and second ports 64, 66. When the LDM 28 is not performing a leak test of the fuel system 10, the canister valve solenoid (CVS) 36 is in an open position to allow air to pass through the CVS fluid passageway 60 between the rest of the system 10 and atmosphere. This enables the system 10 to draw air from the atmosphere through the second port 66 as needed.

The LDM 28 includes a pump 30 arranged in a housing and positioned along the pump fluid passageway 62. One example pump 30 is disclosed in Provisional Application Ser. No. 62/910,708 filed on Oct. 4, 2019, entitled “PUMP FOR EVAPORATIVE EMISSIONS SYSTEM”, which is incorporated herein by reference in its entirety. A check valve 38 is arranged in the pump fluid passageway 62 and selectively blocks the canister 22 from the pump 30 and atmosphere via the second port 66. The pump 30 is arranged in fluid communication along the pump fluid passageway 62 between the check valve 38 and the second port 66. The CVS and pump fluid passageways 60, 62 are parallel to one another, and the pressure sensor 52 is in fluid communication with at least one of the CVS and pump fluid passageways 60, 62 and first and second fluid ports 64, 66. The pressure transducer 52 is arranged to read the pressure in the pump fluid passageway 62 when the CVS 36 is closed, although the pressure transducer 52 can be used for other purposes.

As best shown in FIG. 2, the LDM 28 includes housing 46 to enclose the LDM controller 44, the pump 30, the CVS 36, the check valve 38 and the pressure sensor 52. First and second port 64, 66 are provided by the housing 46. An electrical connector 68 is also provided by the housing 46. The electrical connector 68 may include three pins: one pin is connected to the positive pole of the power supply, and the two pins are connected to the negative poles of the CVS 36 and pump 30 respectively. The engine controller 40 controls the on and off function of the negative poles.

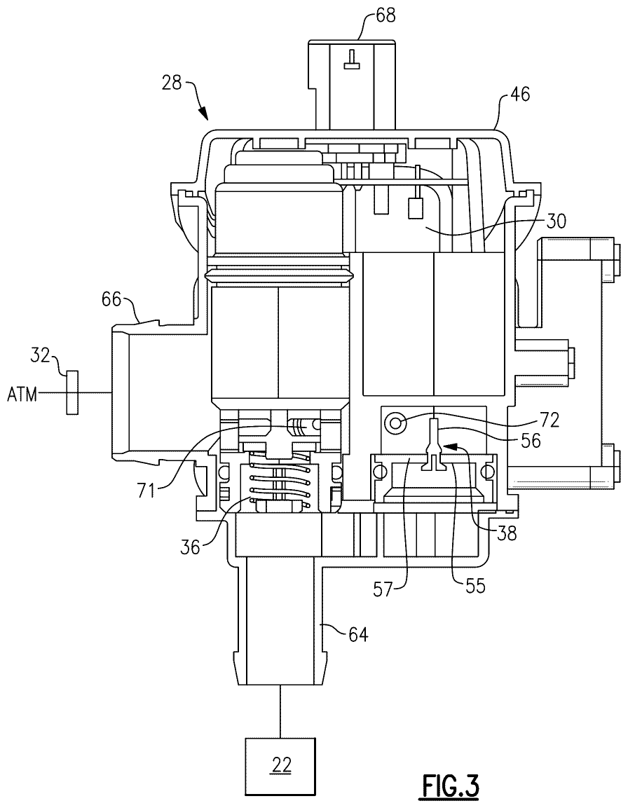

In one example of the LDM 28, as shown in FIG. 3, the check valve 38 is an umbrella valve rather than a second solenoid. Therefore, the example shown in FIG. 3 includes a single cannister valve solenoid 36 and a single umbrella valve 38. The umbrella valve 38 is a one-way, mechanical valve that operates automatically without the need for external control mechanisms such as the LDM controller 44. The umbrella valve 38 responds to changes in pressure differentials to either allow or prevent the flow of air. The umbrella valve 38 has an elastomeric sealing disk 55 that is convex/umbrella shaped and secured to a stem 56. The stem 56 and sealing disk 55 are received by a valve seat 57 such that the stem 56 protrudes through a first side of the seat 57 and the sealing disk 55 is pressed flush to an opposite, second side of the seat 57. The sealing disk 55 of the umbrella valve 38 is configured to pivot between an open and closed position. Specifically, as shown in FIG. 3, the umbrella valve 38 is configured to allow pressurized air to flow from the second port 66 to the first port 64 but prevents air from flowing in the reverse direction, from the first 64 to the second port 66. Thus, when the pressure differential causes air to flow from the atmosphere towards the cannister 22, the valve 38 is opened and the sealing disk 55 is separated from the seat 57. Further, when the pressure differential causes the air to flow from the cannister 22 towards the direction of the pump 30, the valve 38 is closed and the convex sealing disk 55 contacts the seat 57 and forms a seal.

The LDM 28 example that includes the umbrella valve as check valve 38, as shown in FIG. 3, has four operational modes. The four operational modes include a refuel mode, purge mode, pressurization mode, and leak diagnostic mode. The pump 30 is off and the CVS 36 is open when the LDM 28 executes the refuel mode and purge mode. During refueling of the fuel tank 12, the pressure within the evaporative emissions system 10 increases, and the open CVS 36 allows excess fuel vapor from the evaporative emission system 10 to be vented to the atmosphere through the CVS fluid passageway 60 out the second port 66. The LDM 28 enters the purge mode if the pressure transducer's 50, 52 detect a negative pressure differential between the evaporative emissions system 10 and the atmosphere that exceeds a stored threshold value. During the purge mode, air from the atmosphere flows into the LDM 28 through the second port 66. This air directed by the CVS fluid passageway 60 through the open CVS 36, then exits the LDM 28 through the first port 64 to the cannister 22.

The LDM 28 executes the pressurization mode and leak diagnostic mode during a leak test. The leak test requires bringing the evaporative emissions system 10 to a target pressure, closing the evaporative emissions system 10 off to the atmosphere, and the pressure transducers 50, 52 measuring the change in pressure over a period of time, with the controllers 40, 44 comparing those measurements to a stored threshold value. To start the leak test, the LDM 28 operates in its pressurization mode to bring the evaporative emissions system 10 to a target pressure. First, the CVS 36 is activated to close and block flow through the CVS fluid passageway 60. Once the CVS 36 is closed, the pump 30 is activated to draw air from the second port 66 in fluid communication with the atmosphere. The air is channeled through a filter 32 into the pump 30 through a pump inlet 71. The pump 30 ejects the air through a pump outlet 72, into the pump fluid passageway 62, through the umbrella valve 38, and to the cannister 22. The pump 30 continues to draw air into the evaporative emissions system 10 until the evaporative emissions system 10 reaches the target pressure, at which time the LDM 28 enters the leak diagnostic mode. During the leak diagnostic mode, the CVS 36 remains closed to block the flow of air through the CVS fluid passageway 60. The pump 30 is turned off and the pressure differential between the cannister 22 and pump 30 causes the sealing disk 55 of the umbrella valve 38 to seal against the seat 57, effectively isolating the evaporative emission system 10 from the atmosphere.

In the examples described in FIGS. 1-3, the leak boundary of the system 10 includes the fuel filler 14 and cap 16, the purge valve 26, the fresh air side of the canister 22 (side connected to the LDM 28 at first port 64), the vapor dome of the fuel tank 12, and vapor lines connecting all components, including the pump fluid passageway 62.

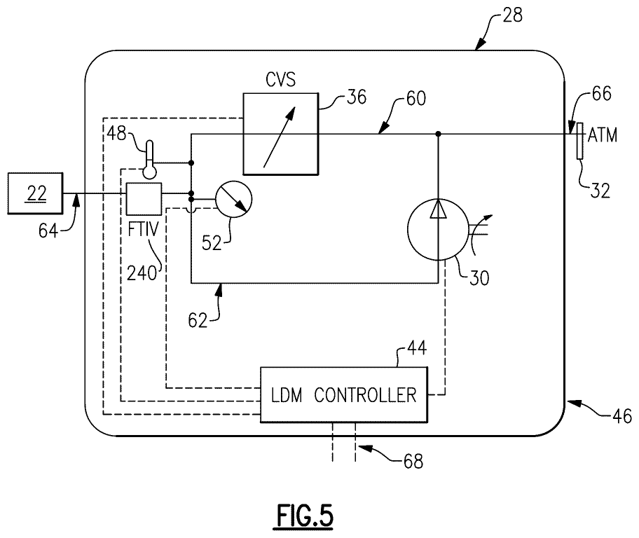

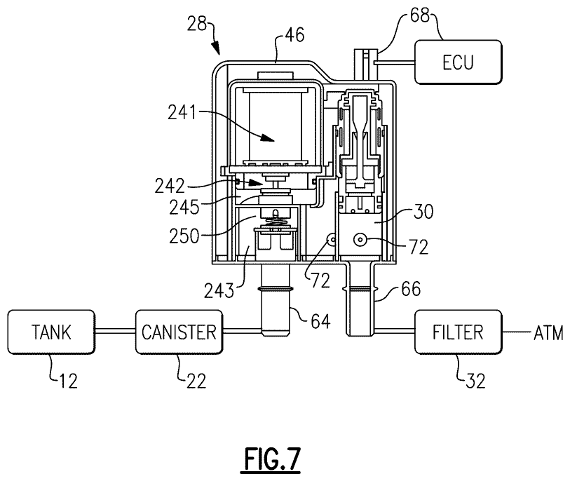

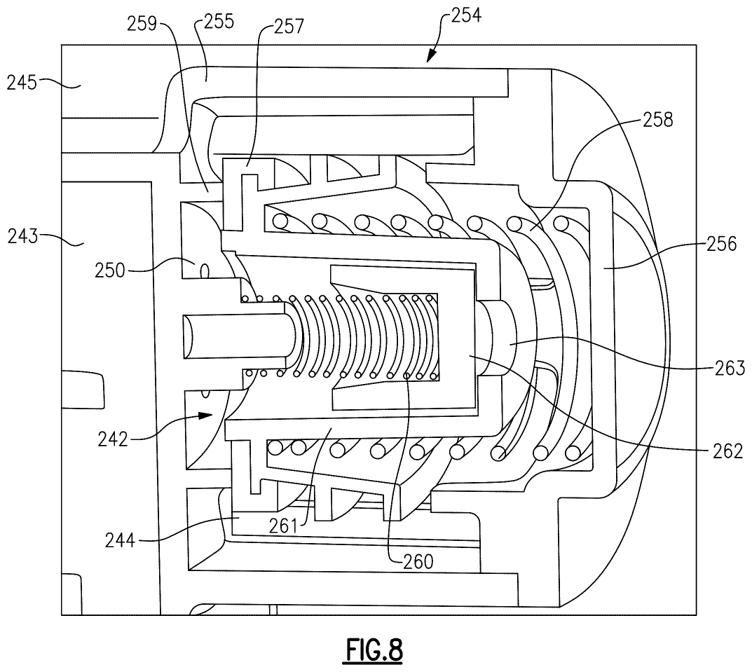

FIGS. 4-8 illustrate another example of the evaporative emissions system 10. In this example, FTIV system 240 is arranged within the LDM housing 46 as opposed to being arranged between the fuel tank 12 and cannister 22. In this configuration, the carbon cannister 22 is still positioned between the fuel tank 12 and LDM 28. Specifically, as shown in FIG. 5, the FTIV system 240 is arranged within the LDM housing 46 between the first port 64 and CVS 36 and between the first port 64 and pump 30. This arrangement of the FTIV system 240 allows for a more compact design of the evaporative emissions system 10 and displaces the need for a check valve 38. Further, the FTIV system 240 includes a solenoid valve 241 that is electrically controlled by the LDM controller 44 and a mechanical bypass system 242 that responds automatically to either positive pressure or negative pressure differentials between the evaporative emissions system 10 and atmosphere. As shown in FIGS. 7-8, the FTIV system 240 includes a first chamber 243, a second chamber 244, and a third chamber 245. The first chamber 243 is in fluid communication with the first port 64. The first chamber 243 includes a relief hole 250 that fluidly communicates the first chamber 243 to the second chamber 244. The mechanical bypass system 242 facilitates the communication of fluid between the second chamber 244 and third chamber 245. The solenoid valve 241 provides an alternative route for the flow of fluid and when opened facilitates the flow of fluid directly between the first chamber 243 and third chamber 245. In the example shown in FIGS. 4-8, the LDM 28 has six operational modes: a vacuum mode, a leak diagnostic mode, a refuel mode, an over pressure relief mode, an under-pressure relief mode, and a non-operating mode.

The LDM 28 executes the vacuum mode and leak diagnostic mode during a leak test. To start the leak test, the LDM 28 executes the vacuum mode and the LDM controller 44 instructs the pump 30 to pull air out of the evaporative emissions system 10 until the evaporative emissions system 10 reaches a target pressure. Further, the LDM controller 44 opens the solenoid valve 241 of FTIV system 240 and closes the CVS 36 to block the flow of air through the CVS fluid passageway 60. Thus, during the vacuum mode, the air is channeled through the pump fluid passageway 62 and directed to the second port 66 and out to the atmosphere. Once a target pressure in the evaporative emissions system 10 has been reached, the LDM 28 executes the leak diagnostic mode. When the LDM 28 executes the leak diagnostic mode, the LDM controller 44 shuts off the pump 30, closes the solenoid valve 241 of FTIV system 240, and opens the CVS 36.

In the example of the evaporative emissions system 10 shown in FIGS. 4-8, the leak boundary of the system 10 includes the fuel filler 14 and cap 16, the purge valve 26, the fresh air side of the canister 22 (side connected to the LDM 28 at first port 64 leading to the FTIV system 240), and the vapor dome of the fuel tank 12.

The pump 30 is off when the LDM 28 executes the refuel mode. During refueling of the fuel tank 12, the pressure within the evaporative emissions system 10 increases. The pressure transducers 50, 52 detect the increase in pressure caused by a build-up of fuel vapor, and if the pressure differential between the evaporative emissions system 10 and atmosphere exceeds a stored threshold value, the LDM controller 44 instructs the solenoid valve 241 of the FTIV system 240 to open. Opening the solenoid valve 241 allows excess fuel vapor from the evaporative emissions system 10 to be channeled through the open CVS 36 and CVS fluid passageway 60 and to be further directed out to the atmosphere through the second port 66.

The mechanical bypass system 242 of the FTIV 240 is configured to perform both the over-pressure relief mode and the under-pressure relief mode. The over-pressure relief mode is performed when the fuel tank 12 pressure reaches 28 kPa to 34 kPa. During execution of the over-pressure relief mode, the solenoid valve 241 is closed, the pump 30 is off, and the CVS 36 is open. As shown in FIG. 8, a first housing 254 is defined by a first and second housing member 255, 256. A sealing face 257 and relief spring mechanism 258 are disposed within the first housing 254. The relief spring mechanism 258 is configured such that when the pressure reaches 28 kPa to 34 kPa, the relief spring mechanism 258 is compressed, and the sealing face 257 disengages from a wall 259 of the first housing member 255, allowing the vapor to enter a third chamber 245 of the FTIV system 240 from the second chamber 244. From the third chamber 245, the vapor is then directed to the CVS fluid passageway 60 and through the CVS 36. The vapor is then directed to the second port 66 and vented out to the atmosphere.

The under-pressure relief mode is performed when the fuel tank 12 pressure is between −13 kPa and −9 kPa. During execution of the under-pressure relief mode, the solenoid valve 241 of the FTIV system 240 is closed, the pump 30 is off, and the CVS 36 is open. Air enters the second port 66 from the atmosphere and is directed by the CVS fluid passageway 60 through CVS 36 and to the third chamber 245 of the FTIV system 240. As shown in FIG. 8 the second chamber 244 also includes an air supply spring mechanism 260 arranged within a second housing 261. The second housing 261 is arranged concentrically within the first housing 254. The second housing 261 includes an aperture 263 at one end that fluidly communicates the relief hole 250 to the third chamber 245. As shown in FIG. 8, a seal plate 262 is secured to the end of the air supply spring mechanism 260 and forms a seal with the second housing 261 to block air from flowing through the aperture 263 when flowing in the direction of the first port 64 to the second port 66. Thus, when air is flowing in the direction of second port 66 to the first port 64, during the under-pressure relief mode, the air exerts pressure on the seal plate 262 causing the air supply spring mechanism 260 to compress and the seal plate 262 to disengage from the second housing 261. The air then flows through the aperture 263 and passes through a void in the second housing 261 to the relief hole 250. The air passes through the relief hole 250, and is directed through the first port 64 to the cannister 22.

The LDM 28 is further configured to execute a non-operating mode during which the solenoid valve 241 of FTIV system 240 is closed, the CVS 36 is open and the pump 30 is off. In the non-operating mode, the relief spring mechanism 258 is not compressed when the fuel tank 12 pressure is less than 28 kPa and the air supply spring mechanism 260 is not compressed when the fuel tank pressure is greater than −9 kPa.

With respect to each of the embodiments shown in FIGS. 1-8, the LDM 28 contains the hardware and software necessary to determine if the system 10 has a leak to the atmosphere.

The LDM controller 44 is used to either A) make a determination if the pressure transducer reading is a pass/fail and directly return a pass or fail indication to the engine controller 40, or B) collect the pressure transducer 52 information and directly report that to the engine controller 40 so the engine controller 40 can make the determination if it is a pass/fail. However, this pressure reading is indicative of a pass/fail. During the leak test, the pressure transducer 52 is in fluid communication with the pump fluid passageway 62 and monitors the pressure condition generated by the pump 30 in the system 10. The pressure transducer 52 is in communication with the LDM controller 44, which determines if there is a variation in pressure over a predetermined amount of time in the evaporative emissions system that might indicate a leak. A change in pressure detected by the pressure transducer 52, which is monitored by the LDM controller 44, can be indicative of a leak. An OBDII system 42 communicates and/or is integrated with the engine controller 40 and uses the pressure information from the LDM controller 44 to generate engine malfunction codes that may be stored and for illuminating a “check engine”light on the vehicle instrument panel indicating vehicle service is needed.

The LDM controller 44 and OBDII system 42 may be integrated or separate, but the engine controller 40 is separate from the LDM controller. In terms of hardware architecture, such the controllers can include a processor, memory, and one or more input and/or output (I/O) device interface(s) that are communicatively coupled via a local interface. The local interface can include, for example but not limited to, one or more buses and/or other wired (e.g., CAN, LIN and/or LAN) or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The controllers may be a hardware device for executing software, particularly software stored in memory. The processor can be a custom made or commercially available processor, a central processing unit (CPU), an auxiliary processor among several processors associated with the controllers, a semiconductor based microprocessor (in the form of a microchip or chip set) or generally any device for executing software instructions.

The memory can include any one or combination of volatile memory elements (e.g., random access memory (RAM, such as DRAM, SRAM, SDRAM, VRAM, etc.)) and/or nonvolatile memory elements (e.g., ROM, etc.). Moreover, the memory may incorporate electronic, magnetic, optical, and/or other types of storage media. The memory can also have a distributed architecture, where various components are situated remotely from one another, but can be accessed by the controller.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

When the controllers are in operation, its processor can be configured to execute software stored within the memory, to communicate data to and from the memory, and to generally control operations of the computing device pursuant to the software. Software in memory, in whole or in part, is read by the processor, perhaps buffered within the processor, and then executed.

The above-described system 10, LDM 28 and method of operation are exemplary only. As can be appreciated, proper operation of the system 10 is highly dependent on desired operation of the various fluid valves (here, pneumatic), which must reliably open and close when commanded by the LDM controller 44 to communicate and block flow when needed during both the evaporative emissions system test procedure and normal engine operation. Further, a worker of skill in the art would recognize that the terms “air”, “vapor”, and “fluid” can be used interchangeably within the bounds of this disclosure.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples. For example, the disclosed pump may be used in applications other than vehicle evaporative systems.

Although an example embodiment has been disclosed, a worker of ordinary skill in this art would recognize that certain modifications would come within the scope of the claims. For that reason, the following claims should be studied to determine their true scope and content.

What is claimed is:

1. A leak detection module (LDM) comprising:
a housing, wherein the housing is positioned between a charcoal cannister and atmosphere and the housing includes a first port fluidly communicating the housing to the cannister and a second port fluidly communicating the housing to the atmosphere;
a canister valve solenoid (CVS) arranged within the housing and in fluid communication along a first fluid passageway between the first and second ports, the CVS is electrically controlled by a controller to move between open and closed positions;
a pump arranged within the housing and in fluid communication along a second passageway between with the first and second ports, wherein the first and second fluid passageways are parallel to each other;
an umbrella check valve arranged within the housing and in fluid communication along the second passageway between the first port and the pump, wherein the umbrella check valve is a one-way mechanical valve that is configured to communicate the flow of fluid from the second port to the first port along the second passageway and to prevent the communication of fluid from the first port to the second port along the second passageway;
a pressure sensor in fluid communication with at least one of the first and second ports.

2. The LDM of claim 1, wherein the umbrella check valve includes a stem that is secured to a convex sealing disk.

3. The LDM of claim 2, wherein the second passageway includes a seat situated perpendicular to and across the second passageway, and the seat is configured to receive the umbrella check valve.

4. The LDM of claim 3, wherein the seat receives the umbrella check valve so that the stem protrudes through a first side of the seat, and the sealing disk is pressed flush to an opposite, second side of the seat.
